(19) United States
(12) Patent Application Publication
(10) Pub. No.: US 2026/0205754 A1
(43) Pub. Date: Jul. 16, 2026

(54) ENVIRONMENTAL SENSING BASED ON AUDIO EQUIPMENT

(71) Applicant: DOLBY INTERNATIONAL AB, Dublin (IE)

(72) Inventors: Daniel ARTEAGA, Barcelona (ES); Natanael David OLAIZ, Barcelona (ES); Jacques KNIPPER, Colmar (FR)

(73) Assignee: DOLBY INTERNATIONAL AB, Dublin (IE)

(21) Appl. No.: 19/128,999

(22) PCT Filed: Sep. 13, 2023
(86) PCT No.: PCT/EP2023/075139

§ 371 Date: May 10, 2025

Related U.S. Application Data
(60) Provisional application No. 63/480,920, filed on Jan. 20, 2023.

(30) Foreign Application Priority Data
Nov. 18, 2022 (ES) P202231001
Jan. 18, 2023 (EP) 23152124.6

(51) Int. Cl. H04S 7/00; G06F 3/16; G06F 21/34; H04R 3/00; H04R 5/02

(52) U.S. Cl. CPC H04S 7/301; G06F 3/165; G06F 21/34; H04R 3/005; H04R 5/02; H04S 2400/11; H04S 2400/13; H04S 2400/15

(57) ABSTRACT

Some disclosed methods involve causing one or more loudspeakers in an audio environment to emit sound and receiving microphone signals from one or more microphones in the audio environment corresponding to an acoustic response of the audio environment to the emitted sound. Some disclosed methods involve detecting, by the control system, a change of the acoustic response of the audio environment. Some disclosed methods involve changing one or more aspects of media processing for media played back by one or more devices in the audio environment based, at least in part, on the change of the acoustic response of the audio environment. Alternatively, or additionally, some disclosed methods may involve changing the lighting in the environment, changing a gain of one or more microphone signals, locking or unlocking one or more devices, or combinations thereof, based at least in part on the change of the acoustic response.

### CROSS-REFERENCE TO RELATED APPLICATIONS

This application claims the benefit of priority from Spanish Patent Application No. P202231001 filed on 18 Nov. 2022, European Patent Application No. 23152124.6 filed on 18 Jan. 2023 and U.S. Provisional Patent Application No. 63/480,920 filed on 20 Jan. 2023, each of which is incorporated by reference herein in its entirety.

### TECHNICAL FIELD

This disclosure pertains to devices, systems and methods for environmental sensing based on signals from one or more audio devices, as well as to responses to such environmental sensing.

### BACKGROUND

Methods, devices and systems for environmental sensing are known. Although existing devices, systems and methods for environmental sensing provide benefits, improved systems and methods would be desirable.

### NOTATION AND NOMENCLATURE

Throughout this disclosure, including in the claims, the terms “speaker,” “loudspeaker” and “audio reproduction transducer” are used synonymously to denote any sound-emitting transducer (or set of transducers) driven by a single speaker feed. A typical set of headphones includes two speakers. A speaker may be implemented to include multiple transducers (e.g., a woofer and a tweeter), which may be driven by a single, common speaker feed or multiple speaker feeds. In some examples, the speaker signal(s) may undergo different processing in different circuitry branches coupled to the different transducers.

Throughout this disclosure, including in the claims, the expression performing an operation “on” a signal or data (e.g., filtering, scaling, transforming, or applying gain to, the signal or data) is used in a broad sense to denote performing the operation directly on the signal or data, or on a processed version of the signal or data (e.g., on a version of the signal that has undergone preliminary filtering or pre-processing prior to performance of the operation thereon).

Throughout this disclosure including in the claims, the expression “system” is used in a broad sense to denote a device, system, or subsystem. For example, a subsystem that implements a decoder may be referred to as a decoder system, and a system including such a subsystem (e.g., a system that generates X output signals in response to multiple inputs, in which the subsystem generates M of the inputs and the other X-M inputs are received from an external source) may also be referred to as a decoder system.

Throughout this disclosure including in the claims, the term “processor” is used in a broad sense to denote a system or device programmable or otherwise configurable (e.g., with software or firmware) to perform operations on data (e.g., audio, or video or other image data). Examples of processors include a field-programmable gate array (or other configurable integrated circuit or chip set), a digital signal processor programmed and/or otherwise configured to perform pipelined processing on audio or other sound data, a programmable general purpose processor or computer, and a programmable microprocessor chip or chip set.

Throughout this disclosure including in the claims, the term “couples” or “coupled” is used to mean either a direct or indirect connection. Thus, if a first device couples to a second device, that connection may be through a direct connection, or through an indirect connection via other devices and connections.

As used herein, a “smart device” is an electronic device, generally configured for communication with one or more other devices (or networks) via various wireless protocols such as Bluetooth, Zigbee, near-field communication, Wi-Fi, light fidelity (Li-Fi), 3G, 4G, 5G, etc., that can operate to some extent interactively and/or autonomously. Several notable types of smart devices are smartphones, smart cars, smart thermostats, smart doorbells, smart locks, smart refrigerators, phablets and tablets, smartwatches, smart bands, smart key chains and smart audio devices. The term “smart device” may also refer to a device that exhibits some properties of ubiquitous computing, such as artificial intelligence.

Herein, we use the expression “smart audio device” to denote a smart device which is either a single-purpose audio device or a multi-purpose audio device (e.g., an audio device that implements at least some aspects of virtual assistant functionality). A single-purpose audio device is a device (e.g., a television (TV)) including or coupled to at least one microphone (and optionally also including or coupled to at least one speaker and/or at least one camera), and which is designed largely or primarily to achieve a single purpose. For example, although a TV typically can play (and is thought of as being capable of playing) audio from program material, in most instances a modern TV runs some operating system on which applications run locally, including the application of watching television. In this sense, a single-purpose audio device having speaker(s) and microphone(s) is often configured to run a local application and/or service to use the speaker(s) and microphone(s) directly. Some single-purpose audio devices may be configured to group together to achieve playing of audio over a zone or user configured area.

One common type of multi-purpose audio device is a smart audio device, such as a “smart speaker,” that implements at least some aspects of virtual assistant functionality, although other aspects of virtual assistant functionality may be implemented by one or more other devices, such as one or more servers with which the multi-purpose audio device is configured for communication. Such a multi-purpose audio device may be referred to herein as a “virtual assistant.” A virtual assistant is a device (e.g., a smart speaker or voice assistant integrated device) including or coupled to at least one microphone (and optionally also including or coupled to at least one speaker and/or at least one camera). In some examples, a virtual assistant may provide an ability to utilize multiple devices (distinct from the virtual assistant) for applications that are in a sense cloud-enabled or otherwise not completely implemented in or on the virtual assistant itself. In other words, at least some aspects of virtual assistant functionality, e.g., speech recognition functionality, may be implemented (at least in part) by one or more servers or other devices with which a virtual assistant may communication via a network, such as the Internet. Virtual assistants may sometimes work together, e.g., in a discrete and conditionally defined way. For example, two or more virtual assistants may work together in the sense that one of them, e.g., the one which is most confident that it has heard a wakeword, responds to the wakeword. The connected virtual assistants may, in some implementations, form a sort of constellation, which may be managed by one main application which may be (or implement) a virtual assistant.

Herein, “wakeword” is used in a broad sense to denote any sound (e.g., a word uttered by a human, or some other sound), where a smart audio device is configured to awake in response to detection of (“hearing”) the sound (using at least one microphone included in or coupled to the smart audio device, or at least one other microphone). In this context, to “awake” denotes that the device enters a state in which it awaits (in other words, is listening for) a sound command. In some instances, what may be referred to herein as a “wakeword” may include more than one word, e.g., a phrase.

Herein, the expression “wakeword detector” denotes a device configured (or software that includes instructions for configuring a device) to search continuously for alignment between real-time sound (e.g., speech) features and a trained model. Typically, a wakeword event is triggered whenever it is determined by a wakeword detector that the probability that a wakeword has been detected exceeds a predefined threshold. For example, the threshold may be a predetermined threshold which is tuned to give a reasonable compromise between rates of false acceptance and false rejection. Following a wakeword event, a device might enter a state (which may be referred to as an “awakened” state or a state of “attentiveness”) in which it listens for a command and passes on a received command to a larger, more computationally-intensive recognizer.

As used herein, the terms “program stream” and “content stream” refer to a collection of one or more audio signals, and in some instances video signals, at least portions of which are meant to be heard together. Examples include a selection of music, a movie soundtrack, a movie, a television program, the audio portion of a television program, a podcast, a live voice call, a synthesized voice response from a smart assistant, etc. In some instances, the content stream may include multiple versions of at least a portion of the audio signals, e.g., the same dialogue in more than one language. In such instances, only one version of the audio data or portion thereof (e.g., a version corresponding to a single language) is intended to be reproduced at one time.

### SUMMARY

At least some aspects of the present disclosure may be implemented via one or more audio processing methods. In some instances, the method(s) may be implemented, at least in part, by a control system and/or via instructions (e.g., software) stored on one or more non-transitory media. Some methods may involve causing, by a control system, one or more loudspeakers in an audio environment to emit sound. According to some examples, the sound emitted by the one or more loudspeakers may not be perceivable by humans. Some methods may involve receiving, by the control system, microphone signals from one or more microphones in the audio environment corresponding to an acoustic response of the audio environment to the sound emitted by the one or more loudspeakers. Some methods may involve detecting, by the control system, a change of the acoustic response of the audio environment. Some methods may involve changing one or more aspects of media processing for media played back by one or more devices in the audio environment based, at least in part, on the change of the acoustic response of the audio environment.

Some examples may involve estimating, by the control system, that the change of the acoustic response of the audio environment corresponds to a presence of one or more persons in the audio environment. Some such examples may involve estimating, by the control system, a location of the one or more persons. According to some examples, changing the one or more aspects of the media processing may involve changing a rendering process for sound played back by one or more audio devices in the audio environment based, at least in part, on the location of the one or more persons. In some examples, estimating the location of the one or more persons may be based, at least in part, on microphone signals received from a plurality of microphones in the audio environment. According to some examples, estimating the location of the one or more persons may be based, at least in part, on sound emitted by a plurality of loudspeakers in the audio environment. In some examples, changing the one or more aspects of the media processing may be based, at least in part, on the presence of the one or more persons in the audio environment.

Some examples may involve estimating, by the control system, that the change of the acoustic response of the audio environment corresponds to an arrival of one or more persons to the audio environment or a departure of one or more persons from the audio environment. When it is estimated that the change of the acoustic response of the audio environment corresponds to the arrival of the one or more persons to the audio environment, some examples may involve initiating or resuming media playback by one or more devices in the audio environment. When it is estimated that the change of the acoustic response of the audio environment corresponds to the departure of the one or more persons from the audio environment, some examples may involve stopping or pausing media playback by one or more devices in the audio environment.

In some examples, detecting the change of the acoustic response of the audio environment may involve energy analysis, correlation analysis or a combination thereof. Alternatively, or additionally, detecting the change of the acoustic response of the audio environment may involve a time-based analysis, a frequency-based analysis, or a combination thereof. Alternatively, or additionally, detecting the change of the acoustic response of the audio environment may involve implementing a trained neural network. According to some examples, detecting the change of the acoustic response of the audio environment may involve implementing a machine learning classifier.

According to some examples, the acoustic response of the audio environment may be, or may correspond to, an impulse response. In some examples, the media processing may involve audio processing, video processing, or a combination thereof.

In some examples, detecting the change of the acoustic response of the audio environment may involve estimating a current acoustic response of the audio environment and comparing the current acoustic response of the audio environment with a previous acoustic response of the audio environment. According to some examples, the method may involve estimating, by the control system and prior to estimating the current acoustic response of the audio environment, the previous acoustic response of the audio environment.

Some examples may involve changing one or more aspects of lighting in the audio environment based, at least in part, on the change of the acoustic response of the audio environment. Alternatively, or additionally, some examples may involve changing a gain of one or more microphone signals based, at least in part, on the change of the acoustic response of the audio environment. Alternatively, or additionally, some examples may involve locking or unlocking one or more devices based, at least in part, on the change of the acoustic response of the audio environment.

Some or all of the operations, functions and/or methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. Accordingly, some innovative aspects of the subject matter described in this disclosure can be implemented via one or more non-transitory media having software stored thereon.

At least some aspects of the present disclosure may be implemented via apparatus. For example, one or more devices (e.g., a system that includes one or more devices) may be capable of performing, at least in part, the methods disclosed herein. In some implementations, an apparatus is, or includes, an audio processing system having an interface system and a control system. The control system may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof. The control system may be configured for implementing some or all of the methods disclosed herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

Like reference numbers and designations in the various drawings indicate like elements.

FIG. 1A shows an example of an audio environment at an instant in time.

FIG. 1B shows a graph that represents one aspect of the acoustic response of the audio environment of FIG. 1A.

FIG. 2A shows an example of the audio environment of FIG. 1A at another time.

FIG. 2B shows a graph that represents one aspect of the acoustic response of the audio environment of FIG. 2A.

FIG. 3 is a block diagram that shows examples of components of an apparatus capable of implementing various aspects of this disclosure.

FIG. 4 is a flow diagram that outlines one example of a disclosed method.

### DETAILED DESCRIPTION OF EMBODIMENTS

Some disclosed implementations involve an environmental awareness technology that is based on microphone signals from one or more audio devices in an audio environment. The audio environment may, in some examples, be a home audio environment. In other examples, the audio environment may be another type of environment, such as an office environment, a conference room environment, an automobile environment, a train environment, a street or sidewalk environment, a park environment, etc.

According to some implementations, one or more novel aspects may reside in audio processing devices, systems and methods. However, in some implementations, one or more previously-existing loudspeakers and microphones may be used to obtain data that is used to evaluate the state of the audio environment. Some such implementations may leverage already-existing devices to capture the acoustic footprints of the audio environment in a way that is not perceivable by the user. By monitoring the acoustic response of the audio environment, some disclosed implementations may be configured to estimate the conditions in the audio environment, such as the presence of one or more people, the arrival or departure of one or more people, etc.

Alternatively, or additionally, one or more novel aspects may reside in disclosed responses to changes in an audio environment. In some implementations, one or more other types of previously-existing devices, such as one or more loudspeakers, televisions, laptops, cellular telephones, smart speakers, car audio systems, lights, etc., may be controlled according to detected changes in the acoustic response of the audio environment.

For example, some disclosed methods may involve changing one or more aspects of media processing for media played back by one or more devices in the audio environment based, at least in part, on the change of the acoustic response of the audio environment. In some such examples, changing one or more aspects of the media processing may involve changing a rendering process for sound played back by one or more audio devices in the audio environment.

Alternatively, or additionally, some disclosed methods may involve changing the lighting in the environment, changing a gain of one or more microphone signals, locking or unlocking one or more devices, initiating or resuming media playback, stopping or pausing media playback, or combinations thereof, based at least in part on the change of the acoustic response.

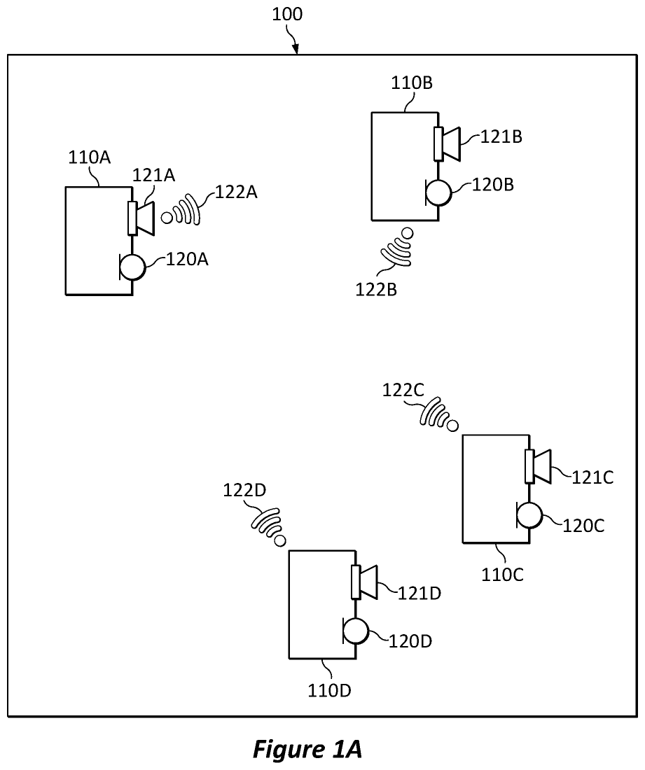

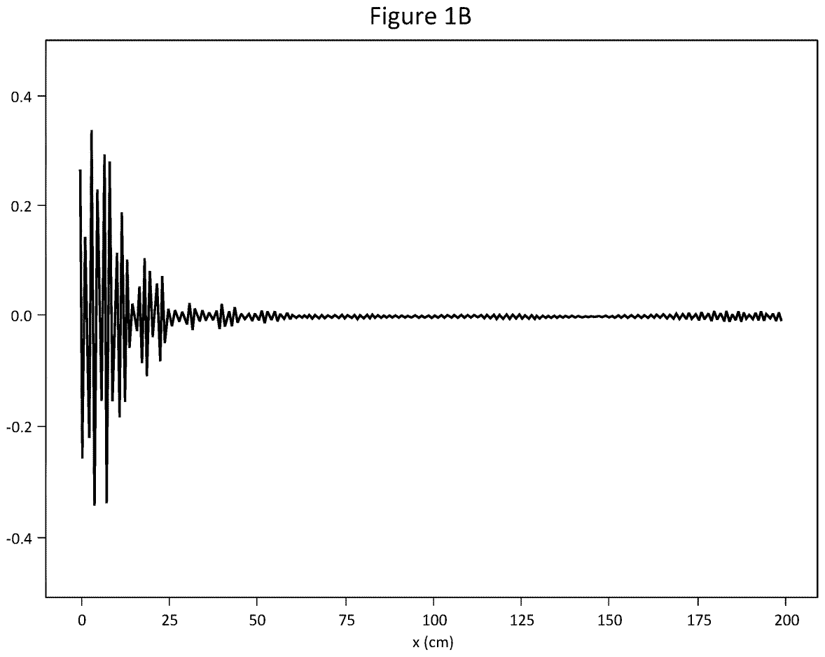

FIG. 1A shows an example of an audio environment at an instant in time. As with other figures provided herein, the types and numbers of elements shown in FIG. 1A are merely provided by way of example. Other implementations may include more, fewer and/or different types and numbers of elements.

According to this example, the audio environment 100 includes audio devices 110A, 110B, 110C and 110D. In this example, each the audio devices 110A-110D includes a respective one of the microphones 120A, 120B, 120C and 120D, as well as a respective one of the loudspeakers 121A, 121B, 121C and 121D. According to some examples, each the audio devices 110A-110D may be a smart audio device, such as a smart speaker.

In this example, a control system of a device in the audio environment 100 is configured to cause the loudspeakers 121A-121D to emit sound 122A, 122B, 122C and 122D, respectively. In some examples, the sound 122A-122D may be outside a range of frequencies (e.g., 20-20,000 Hz) that is audible to human beings. However, in other examples, the sound 122A-122D may be within the range of frequencies that is audible to human beings. Even if the sound 122A-122D is within the range of frequencies that is audible to human beings, the sound 122A-122D may or may not be detectable by a person, depending on the particular implementation. Further examples and details are provided below.

According to this example, the control system is configured to receive microphone signals from one or more microphones in the audio environment corresponding to an acoustic response of the audio environment to the sound emitted by one or more of the audio devices 110A-110D. In this example, the control system is configured to determine the acoustic response of the audio environment 100 according to the microphone signals. In some examples, the control system may be configured to determine the acoustic response of the audio environment 100 at different times, such as times corresponding to consecutive measurements of the acoustic response. According to some such examples, the control system may be configured to detect a change of the acoustic response of the audio environment.

According to some examples, the control system may be configured to change one or more aspects of media processing for media played back by one or more devices in the audio environment (such as sound played back by one or more of the audio devices 110A-110D, video, sound, or combinations thereof played back by a television, etc.) based, at least in part, on the change of the acoustic response of the audio environment.

In some examples, the control system may be the control system of an orchestrating device, such as what may be referred to herein as a smart home hub.

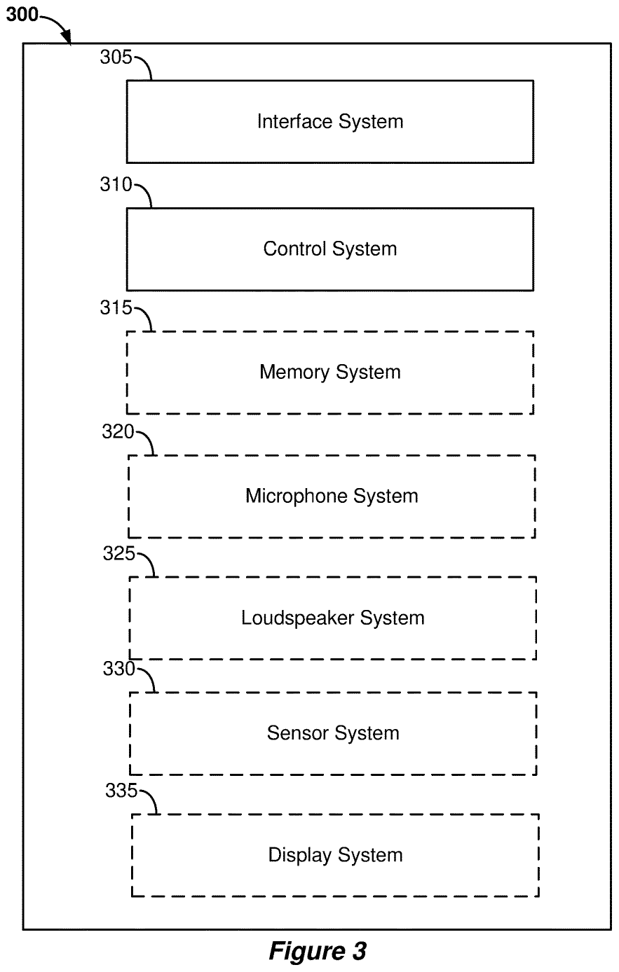

The orchestrating device may be one of the audio devices 110A-110D in some examples. The orchestrating device may be an instance of the apparatus 300 that is described below with reference to FIG. 3. In some such examples, the orchestrating device may be configured to cause two or more of the loudspeakers 121A-121D to emit sound. According to some such examples, the orchestrating device may be configured to receive microphone signals from microphones of two or more of the audio devices 110A-110D corresponding to an acoustic response of the audio environment to the sound emitted by two or more of the audio devices 110A-110D. In some such examples, the orchestrating device may be configured to determine the acoustic response of the audio environment 100 according to the microphone signals.

According to some such examples, the orchestrating device may be configured to determine changes in the acoustic response of the audio environment 100 according to microphone signals received at multiple times, such as times corresponding to consecutive measurements of the acoustic response. In some examples, the orchestrating device may be configured to change one or more aspects of media processing for media played back by one or more devices in the audio environment (such as sound played back by one or more of the audio devices 110A-110D, video, sound, or combinations thereof played back by a television, etc.) based, at least in part, on the change of the acoustic response of the audio environment.

FIG. 1B shows a graph that represents one aspect of the acoustic response of the audio environment of FIG. 1A. According to this example, the acoustic response is the impulse response of the audio environment 100. In this example, the impulse response was determined by the control system according to sound emitted by a single audio device, such as the audio device 110A, and according to microphone signals from the same audio device. In this example, the vertical axis represents the acoustic pressure measured by a microphone, or by a microphone array, and the horizontal axis represents distance in centimeters. In this example, the distance in centimeters that is represented by the vertical axis was obtained by multiplying time-based impulse response values, which correspond to microphone signals received by one or more microphones of the audio device, by the speed of sound. Accordingly, the distances indicated in FIG. 1B correspond to distances from a particular audio device that emitted the sound and provided the microphone signals that were used to determine the impulse response of the audio environment 100.

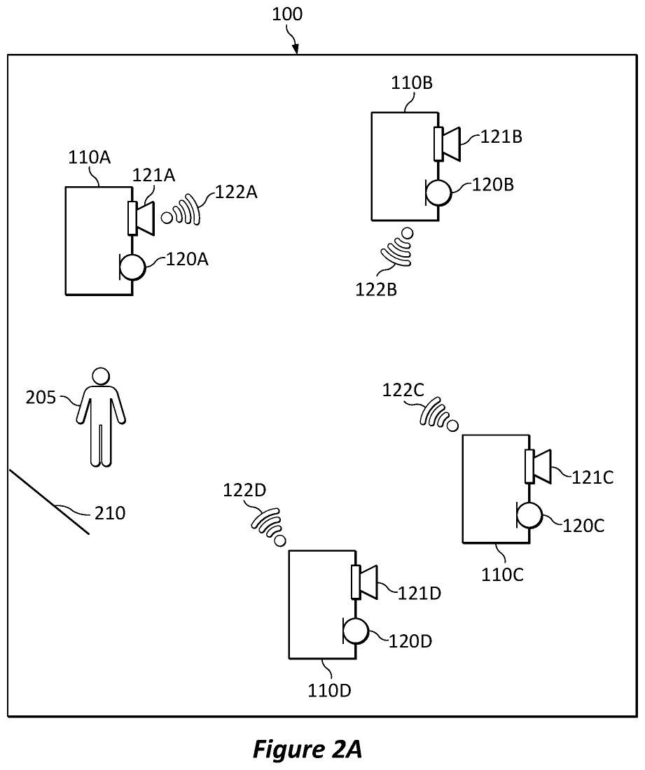

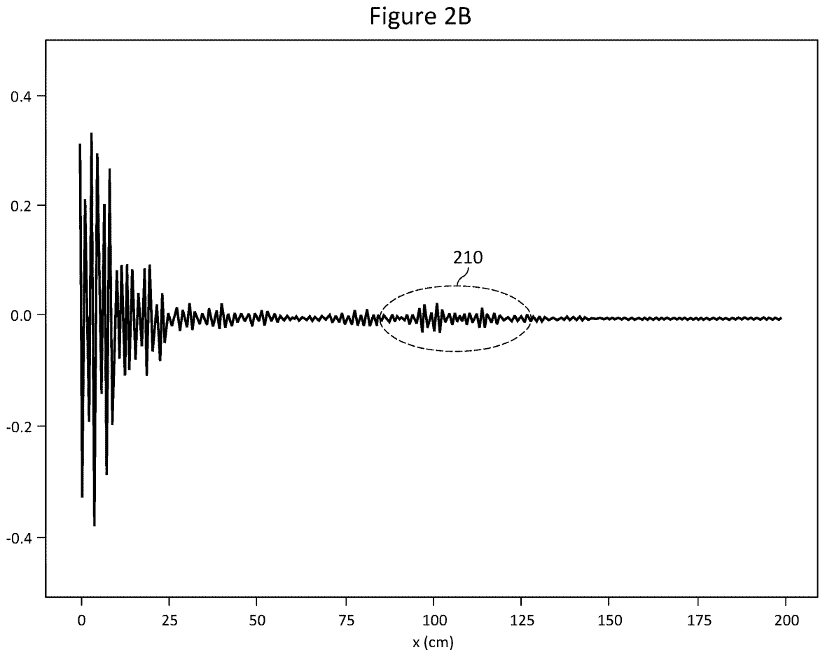

FIG. 2A shows an example of the audio environment of FIG. 1A at another time. According to this example, changes to the acoustic response of the audio environment 100 are being caused by the entry of the person 205 into the audio environment 100. In this example, the person 205 entered the audio environment 100 through the door 210, which has been left open in this example. Accordingly, the changes to the acoustic response of the audio environment 100 may be caused by the presence of the person 205 (whether or not the person 205 is speaking) and by the changed position of the door 210.

FIG. 2B shows a graph that represents the acoustic response of the audio environment of FIG. 2A. According to this example, as with FIG. 1B, the acoustic response is the impulse response of the audio environment 100 and was determined by the control system according to sound emitted by, and according to microphone signals from, the same audio device that was used to determine the acoustic response shown in FIG. 1B. Accordingly, the differences between the acoustic response shown in FIG. 1B and the acoustic response shown in FIG. 2B correspond to one or more changes in the audio environment 100 with respect to the state shown in FIG. 1A. The area 210 shows changes in the acoustic response in a distance range of about 90-130 centimeters from the audio device that emitted the sounds and provided the microphone signals that were used to determine the impulse response of the audio environment 100. These changes in the acoustic response correspond to the presence of the person 205, the open door 210, or a combination thereof.

In some examples, another determination of the acoustic response may be made at one or more subsequent times. For example, another determination of the acoustic response may be made responsive to a door closing sound. The corresponding change in acoustic response would allow the control system to distinguish the acoustic response corresponding to the presence of the person from the acoustic response corresponding to the open door. In another example, a determination of the acoustic response may be made responsive to an indication of the person 205 moving to a different location of the audio environment, responsive to an indication of the person 205 sitting down on a sofa or chair, responsive to an indication of the person 205 leaving the audio environment, responsive to an indication of another person entering the audio environment, etc. Alternatively, or additionally, additional determinations of the acoustic response may be made after a time interval, which may be a configurable time interval.

As described in more detail below, in some alternative examples a determination of the acoustic response of the audio environment 100, or another audio environment, may be made according to sound emitted by, and microphone signals from, two or more audio devices in the audio environment.

FIG. 3 is a block diagram that shows examples of components of an apparatus capable of implementing various aspects of this disclosure. As with other figures provided herein, the types and numbers of elements shown in FIG. 3 are merely provided by way of example. Other implementations may include more, fewer and/or different types and numbers of elements. According to some examples, the apparatus 300 may be configured for performing at least some of the methods disclosed herein. In some implementations, the apparatus 300 may be, or may include, one or more components of an audio system. For example, the apparatus 300 may be an audio device, such as a smart audio device, in some implementations. In other examples, the examples, the apparatus 300 may be a mobile device (such as a cellular telephone), a laptop computer, a tablet device, a smart home hub, a television or another type of device.

According to some examples, the apparatus 300 may be, or may include, an orchestrating device that is configured to provide control signals to two or more devices of an audio environment. In some examples, the control signals may be provided by the orchestrating device in order to coordinate aspects of audio playback, such as to control the playback of multiple audio devices according to an orchestrated rendering process. Some examples are disclosed herein. In some examples, the orchestrating device may be, or may include, what may be referred to herein as a smart home hub. In other examples, the orchestrating device may be, or may include, a smart audio device, a mobile device (such as a cellular telephone), a laptop computer, a tablet device, a television or another type of device.

According to some alternative implementations the apparatus 300 may be, or may include, a server. In some such examples, the apparatus 300 may be, or may include, an encoder. In some examples, the apparatus 300 may be, or may include, a decoder. Accordingly, in some instances the apparatus 300 may be a device that is configured for use within an audio environment, such as a home audio environment, whereas in other instances the apparatus 300 may be a device that is configured for use in “the cloud,” e.g., a server.

In this example, the apparatus 300 includes an interface system 305 and a control system 310. The interface system 305 may, in some implementations, be configured for communication with one or more other devices of an audio environment. The audio environment may, in some examples, be a home audio environment. In other examples, the audio environment may be another type of environment, such as an office environment, an automobile environment, a train environment, a street or sidewalk environment, a park environment, etc. The interface system 305 may, in some implementations, be configured for exchanging control information and associated data with audio devices of the audio environment. The control information and associated data may, in some examples, pertain to one or more software applications that the apparatus 300 is executing.

The interface system 305 may, in some implementations, be configured for receiving, or for providing, a content stream. The content stream may include audio data. The audio data may include, but may not be limited to, audio signals. In some instances, the audio data may include spatial data, such as channel data and/or spatial metadata. Metadata may, for example, have been provided by what may be referred to herein as an “encoder.” In some examples, the content stream may include video data and audio data corresponding to the video data.

The interface system 305 may include one or more network interfaces and/or one or more external device interfaces (such as one or more universal serial bus (USB) interfaces). According to some implementations, the interface system 305 may include one or more wireless interfaces. The interface system 305 may include one or more devices for implementing a user interface, such as one or more microphones, one or more speakers, a display system, a touch sensor system and/or a gesture sensor system. Accordingly, while some such devices are represented separately in FIG. 3, such devices may, in some examples, correspond with aspects of the interface system 305.

In some examples, the interface system 305 may include one or more interfaces between the control system 310 and a memory system, such as the optional memory system 315 shown in FIG. 3. However, the control system 310 may include a memory system in some instances. The interface system 305 may, in some implementations, be configured for receiving input from one or more microphones in an environment. In some implementations, the interface system 305 may be configured for providing control signals from an orchestrating device to one or more other devices in an audio environment.

The control system 310 may, for example, include a general purpose single- or multi-chip processor, a digital signal processor (DSP), an application specific integrated circuit (ASIC), a field programmable gate array (FPGA) or other programmable logic device, discrete gate or transistor logic, and/or discrete hardware components.

In some implementations, the control system 310 may reside in more than one device. For example, in some implementations a portion of the control system 310 may reside in a device within one of the environments depicted herein and another portion of the control system 310 may reside in a device that is outside the environment, such as a server, a mobile device (such as a smartphone or a tablet computer), etc. In other examples, a portion of the control system 310 may reside in a device within one of the environments depicted herein and another portion of the control system 310 may reside in one or more other devices of the environment. For example, control system functionality may be distributed across multiple smart audio devices of an environment, or may be shared by an orchestrating device (such as what may be referred to herein as a smart home hub) and one or more other devices of the environment. In other examples, a portion of the control system 310 may reside in a device that is implementing a cloud-based service, such as a server, and another portion of the control system 310 may reside in another device that is implementing the cloud-based service, such as another server, a memory device, etc. The interface system 305 also may, in some examples, reside in more than one device.

In some implementations, the control system 310 may be configured for performing, at least in part, the methods disclosed herein. According to some examples, the control system 310 may be configured to cause one or more loudspeakers in an audio environment to emit sound. In some such examples, the control system 310 may be configured to receive microphone signals from one or more microphones in the audio environment corresponding to an acoustic response of the audio environment to the emitted sound. In some such examples, the control system 310 may be configured to detect a change of the acoustic response of the audio environment. For example, detecting the change of the acoustic response of the audio environment may involve estimating a current acoustic response of the audio environment and comparing the current acoustic response of the audio environment with a previous acoustic response of the audio environment. In some such examples, the control system 310 may have previously estimated the previous acoustic response.

According to some examples, the control system 310 may be configured to change one or more aspects of media processing for media played back by one or more devices in the audio environment based, at least in part, on the change of the acoustic response of the audio environment. Alternatively, or additionally, the control system 310 may be configured to change the lighting in the environment, to change a gain of one or more microphone signals, to lock or unlock one or more devices, or combinations thereof, based at least in part on the change of the acoustic response.

Some or all of the methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. The one or more non-transitory media may, for example, reside in the optional memory system 315 shown in FIG. 3 and/or in the control system 310. Accordingly, various innovative aspects of the subject matter described in this disclosure can be implemented in one or more non-transitory media having software stored thereon. The software may, for example, include instructions for controlling at least one device to perform some or all of the methods disclosed herein. The software may, for example, be executable by one or more components of a control system such as the control system 310 of FIG. 3.

In some examples, the apparatus 300 may include the optional microphone system 320 shown in FIG. 3. The optional microphone system 320 may include one or more microphones. According to some examples, the optional microphone system 320 may include an array of microphones. In some examples, the array of microphones may be configured to determine direction of arrival (DOA) and/or time of arrival (TOA) information, e.g., according to instructions from the control system 310. The array of microphones may, in some instances, be configured for receive-side beamforming, e.g., according to instructions from the control system 310. In some implementations, one or more of the microphones may be part of, or associated with, another device, such as a speaker of the speaker system, a smart audio device, etc. In some examples, the apparatus 300 may not include a microphone system 320. However, in some such implementations the apparatus 300 may nonetheless be configured to receive microphone data for one or more microphones in an audio environment via the interface system 310. In some such implementations, a cloud-based implementation of the apparatus 300 may be configured to receive microphone data, or data corresponding to the microphone data, from one or more microphones in an audio environment via the interface system 310.

According to some implementations, the apparatus 300 may include the optional loudspeaker system 325 shown in FIG. 3. The optional loudspeaker system 325 may include one or more loudspeakers, which also may be referred to herein as “speakers” or, more generally, as “audio reproduction transducers.” In some examples (e.g., cloud-based implementations), the apparatus 300 may not include a loudspeaker system 325.

In some implementations, the apparatus 300 may include the optional sensor system 330 shown in FIG. 3. The optional sensor system 330 may include one or more touch sensors, gesture sensors, motion detectors, etc. According to some implementations, the optional sensor system 330 may include one or more cameras. In some implementations, the cameras may be free-standing cameras. In some examples, one or more cameras of the optional sensor system 330 may reside in a smart audio device, which may be a single purpose audio device or a virtual assistant. In some such examples, one or more cameras of the optional sensor system 330 may reside in a television, a mobile phone or a smart speaker. In some examples, the apparatus 300 may not include a sensor system 330. However, in some such implementations the apparatus 300 may nonetheless be configured to receive sensor data for one or more sensors (such as cameras) in an audio environment via the interface system 310.

In some implementations, the apparatus 300 may include the optional display system 335 shown in FIG. 3. The optional display system 335 may include one or more displays, such as one or more light-emitting diode (LED) displays. In some instances, the optional display system 335 may include one or more organic light-emitting diode (OLED) displays. In some examples, the optional display system 335 may include one or more displays of a smart audio device. In other examples, the optional display system 335 may include a television display, a laptop display, a mobile device display, or another type of display. In some examples wherein the apparatus 300 includes the display system 335, the sensor system 330 may include a touch sensor system and/or a gesture sensor system proximate one or more displays of the display system 335.

According to some such implementations, the control system 310 may be configured for controlling the display system 335 to present one or more graphical user interfaces (GUIs).

According to some such examples the apparatus 300 may be, or may include, a smart audio device, such as a smart speaker. In some such implementations the apparatus 300 may be, or may include, a wakeword detector. For example, the apparatus 300 may be configured to implement (at least in part) a virtual assistant.

According to some examples, a disclosed method may include at least an acoustic response acquisition process and an acoustics analysis process. The acoustic response acquisition process will generally involve one or more instances of determining the acoustic response of the audio environment according to some objective criterion or criteria. In some examples, the acoustic response may be represented either by the impulse response of the audio environment or by another quantity that closely resembles the impulse response of the audio environment (such as a band-limited impulse response).

Accordingly, this disclosure may sometimes refer to the acoustic response of the audio environment as an impulse response (IR), although various types of acoustic response representations are contemplated by the inventors.

According to some examples, the acoustics analysis process involves analyzing the results of one or more instances of measuring the acoustic response of the audio environment. Various examples are described below.

In some examples, the method also may include determining a response that is based, at least in part, on the acoustic response of the audio environment, or a change in the acoustic response, as determined by the acoustics analysis process. Some such examples also may involve implementing the response, instructing one or more devices to implement the response, or a combination thereof. According to some such examples, implementing the response may involve changing one or more aspects of media processing for media played back by one or more devices in the audio environment based, at least in part, on a change of the acoustic response of the audio environment. The media processing may involve audio processing, video processing, or a combination thereof.

Alternatively, or additionally, implementing the response may involve changing one or more aspects of lighting in the environment, changing a gain of one or more microphone signals, locking or unlocking one or more devices, or combinations thereof, based at least in part on the change of the acoustic response of the audio environment.

### Acoustic Response Acquisition

In some examples, the acoustic response acquisition process may involve using one loudspeaker and one microphone. According to some alternative examples, the acoustic response acquisition process may involve using multiple loudspeakers, multiple microphones, or combinations thereof. In the “one loudspeaker and one microphone” case, for every instant of time, or every time interval, there will generally be only one measured acoustic response. In cases involving multiple loudspeakers, multiple microphones, or combinations thereof, there will be n x m measured acoustic responses (such as impulse responses (IRs)), with n representing the number of loudspeakers and m representing the number of microphones.

Transparent acoustic response acquisition, in other words acquiring an acoustic response in a way that it is not perceptible by a person, provides potential advantages. One such potential advantage is an improved experience for any listener who may be in the audio environment. Another related advantage is the ability to make relatively more frequent acoustic response measurements, under the assumption that the corresponding acoustic response acquisitions will not be annoying or distracting to any listener who may be in the audio environment.

Accordingly, in some examples the impulse response, or some quantity analogous to the impulse response, may be acquired according to a method that is not perceivable by a human in the audio environment. Such methods include, but are not limited to, the following:
1. Methods relying on non-audible signals, such as sounds that are outside of a frequency range that is perceivable to human beings;
2. Methods relying on hidden or masked signals; and
3. Methods relying on normal audio content being reproduced, examples of which are described below.

### Non-Audible Signals

Swept-sine methods involve using a sinusoidal excitation with a frequency increasing exponentially in time. The response of the excitation may be recorded by a microphone and the impulse response may be extracted by a deconvolution technique. In other words, the acoustic response may be determined by deconvolving the recorded response with the input swept-sine signal.

If the swept sine signal only includes frequencies above 20 KHz, the resulting signal will not be heard by the vast majority of adult humans and will thus be transparent for a typical adult person. For example, if the swept sine is bandlimited between 20 and 24 KHz, the resulting signal will generally not be heard by adult humans. However, in some alternative examples, the swept-sine signal may have a different minimum frequency, a different maximum frequency, or a combination thereof.

### Hidden or Masked Signals

The maximum-length sequence (MLS) method is based on the excitation by a periodic pseudorandom signal having the same spectrum as white nose, but more favorable statistical properties. With the MLS technique, the impulse response is obtained by circular cross-correlation. The MLS method benefits from a good signal-to-noise ratio, allowing the acquisition of the impulse response in presence of noise or other signals.

The MLS method allows computing the impulse response from a low-level MLS signal, without requiring silence from other sound sources. If audio content is being played back, the MLS signal can be totally masked beyond the emitted sound, and thus will be imperceptible.

Other similar strategies can be followed to hide a test signal in the audio content being played back in an audio environment. Some such examples may involve monitoring the time-frequency response and the playback amplitude of both the hidden test signal and the playback signal, and ensuring that the hidden test signal is always masked by the playback signal according to the principles of psychoacoustic masking.

### Normal Audio Content

It is also possible to measure the impulse response from normal audio content being emitted from a loudspeaker. In broad terms, the spectral division of the recorded signal by the emitted audio signal leads to the impulse response. However, in practice, problems might arise when some frequencies are missing or there is correlated content from multiple channels. There are several strategies for tackling this. For example, an adaptive filter may be used to extract the impulse response from the emitted audio content.

### Acoustics Analysis

In some disclosed acoustics analysis processes, the acquired acoustic response(s) are analyzed to search for changes in the acoustic response of the audio environment. The acquired acoustic response(s) may be monitored and investigated. The acoustics analysis process may involve various techniques, depending on the particular implementation. Such techniques may include one or more of the following list of examples.

### Energy Analysis

Energy analysis methods are well suited to determine the status of the audio environment at given regions of space. Given a measured impulse response IRᵢ(t), the ratio of energy detected during a time window to the total detected energy may be expressed as follows:

$${r}_{i} = \frac{{\int }_{τ - T / 2}^{τ + T / 2} {\vert {IR}_{i} ( t ) \vert}^{2} dt}{{\int }_{- ∞}^{∞} {\vert {IR}_{i} ( t ) \vert}^{2} dt}$$

In the foregoing equation, z represents the center time and T represents the time window. The time T may be chosen as a function of the distance to the environmental event being monitored:

$$τ = d / c$$

In the foregoing equation, d represents the distance to the environmental event being monitored and c represents the speed of sound, taking into account both the time of flight between the speaker and the location of an acoustic event and the time of flight from the location of the acoustic event to the microphone. For example, d could represent the distance from an audio device that measured the acoustic response to a doorway through which a person may enter or exit the audio environment. The time T corresponds to the spatial extent being monitored: a relatively smaller value of T would correspond to a relatively smaller detection region.

According to some examples, a threshold value of the energy ratio may be chosen or determined. In some such examples, a value larger than the threshold would indicate the presence of an environmental event (such as the entry of a person into the audio environment), whereas a value smaller than the threshold would indicate the absence of the environmental event. Some examples may involve more than one threshold. For example, some examples may involve a smaller threshold that indicates the possible detection of a particular event, such as the presence of a person, and a larger threshold that indicates a relatively more certain detection of the event. In another example, a smaller threshold may indicate the detection of a one event, such as the opening of the door 210 of FIG. 2, and a larger threshold may indicate the detection of another event, such as the presence of the person 205 within the audio environment 100, the presence of the person 205 within a particular distance of an audio device, etc. According to some examples, a threshold may be determined according to one or more prior occurrences of the same event. In some examples, the occurrence of an event corresponding to a threshold may be determined, or validated, according to input from another type of sensor, such as camera data, according to input from a person, etc. For example, if the presence of a person or a cat is estimated based on microphone data, in some examples camera data may be used to determine whether this estimation is correct.

In some examples, the values of τ and T might not be unique, and instead multiple sets of values (τ, T) may be analyzed, each one associated to different thresholds. Each one of the pairs of values may correspond to a different energy analysis. Such methods allows a control system to simultaneously explore the presence of an environmental event in multiple spatial locations.

Some energy-based examples may be based, at least in part, on the analysis of frequency ranges. Such frequency-based examples may be implemented in addition to analyses that involve a time window. Some examples are described below.

### Correlation Analysis

A correlation analysis is well suited for detecting changes in the environment, such as the movement of a person or the opening of a door. Given two successive impulse responses IRᵢ(t) and IRᵢ₊₁(t), the correlation cᵢ between the two impulse responses may be expressed as follows:

$${c}_{i} = {\int }_{τ - T / 2}^{τ + T / 2} {IR}_{i} ( t ) {IR}_{i + 1} ( t ) dt$$

In the foregoing equation, r represents the central time of the correlation and T represents the correlation extent. Both τ and T may be chosen as described above. In some examples, a detection value dᵢ may be expressed as follows:

$${d}_{i} = 1 - {c}_{i} = 1 - {\int }_{τ - T / 2}^{τ + T / 2} {IR}_{i} ( t ) {IR}_{t + 1} ( t ) dt$$

A small detection value indicates that the acoustic response (and presumably the state of the audio environment) is stable, whereas a high detection value indicates a sudden change of the acoustic response (and presumably the state of the audio environment) around the detection time. An indication of a change in the audio environment may, in some examples, be based on a thresholding method such as those described above in the energy analysis section.

Similarly as above, the values of τ and T might not be unique, and instead there might be multiple set of values (τ, T) analyzed, each one associated to different thresholds. Each one of the pairs of values may correspond to a different correlation analysis.

In some other examples, the values of r and T might be sufficiently large so that not only the direct sound from the source to the environmental change location is being monitored, but also the entire reverberation tail, including multiple room reflections. This kind of approach is well suited for monitoring entire rooms, including blind spots not in the direct line of sight of the emitter.

### Time-Frequency Extensions

Both the energy analysis and the correlation analysis described above are based, directly or indirectly, on the time domain. Some energy-based examples and correlation-based examples may be based, at least in part, on the analysis of frequency ranges.

Some such frequency-based examples may be implemented in addition to analyses that involve a time window. For example, some implementations may involve energy analyses, correlation analyses, or combinations thereof that are similar to those described above, but which involve a time-frequency representation (spectrogram) in which the integral (or sum) runs over a certain time-frequency region.

An event caused by a relatively smaller object or being, such as a cat or a small dog, may affect the acoustics of the room only at higher frequencies (roughly speaking above 500 Hz), whereas an event caused by an adult human may affect the acoustics at much lower frequencies (roughly speaking above 100 Hz). Accordingly, time-based and frequency-based examples may provide a more accurate estimate of a current environmental state and may help to eliminate false positives. For example, based on a time-based analysis alone a control system might have determined that a person had entered the audio environment, when in fact a cat or a small dog had entered the audio environment.

### Multiple Transducers

Some implementations involve combining acoustic responses that are caused and detected by multiple transducers. In such cases, the energy ratios and detection values described above may be represented as matrices, for example matrices having as many rows as sound emitters and as many columns as sound receivers. In some examples, there may be n×m acoustic responses, (such as impulse responses (IRs)), with n representing the number of loudspeakers and m representing the number of microphones. Potential advantages of measuring an acoustic response using multiple audio devices include increased robustness of the measured acoustic responses and the possibility of using the measured acoustic responses for localization, such as for estimating the locations of audio devices in the audio environment, the location of one or more persons in the audio environment, etc.

Home Environment Example with Smart Speakers

In this example we will consider a home audio environment that includes s smart speakers, each of which is capable of both emitting and detecting sound. When a person enters a room, the acoustics of the room are modified, and these changes can be detected by the system regardless of whether the person makes any sound.

In some multiple-device examples, s×s impulse responses (IRs) will be measured. We can label those impulse responses as IRij(t), with the first index i indicating the sound receiver device and the second indexj indicating the sound emitter device.

Clearly, having multiple IRs being measured can add robustness to methods of monitoring the acoustic state of an audio environment. Moreover, measuring multiple IRs also can add localization capabilities, such as the capability to estimate the location of a person in the audio environment. The following discussion includes various methods for using acoustic responses measured by multiple devices in an audio environment.

### Person Detection

The presence of a person in the room may, in some examples, be detected via a correlation-based method. For example, each acoustic response could be correlated with the acoustic response acquired during a previous time interval, for example by using the correlation method described above.

One advantage of having multiple acoustic responses for person detection is that of robustness. In some examples, a determination of a person's presence may only be made when at least a threshold number, fraction, percentage, etc., of all acoustic responses indicate the presence of the person in the audio environment. In one such example, a determination of a person's presence may only be made when at least half of all acoustic responses indicate the presence of the person in the audio environment. In another such example, a determination of a person's presence may only be made when at least ¾ of all acoustic responses indicate the presence of the person in the audio environment. Other examples may involve higher or lower fractions, percentages, etc.

### Person Location Using Self-IRs

We define a self-IR as being an IR measured according to sound emitted and captured by the same audio device. A self-IR may be represented as IRᵢᵢ(t), where i corresponds to the index of the audio device in question.

The presence of a person in the room will generally cause a change in the self-IRs of each audio device. Typically, there will be a disturbance at time r in each self-IR, where τ=2 d/c, with d representing the distance from the person to the device and c representing the speed of sound. The factor 2 accounts for the time it takes for the emitted sound to travel to the person and to return to the audio device after being reflected back by the person's body.

In some examples, a control system may detect the time r for each audio device independently, for example by performing a variation of the energy analysis. According to some such examples, a predefined set of times r may be analyzed, and the one leading to a highest energy ratio may be selected. Once the times z, have been established for each audio device, the corresponding distances may be found by the equation τᵢ=2 dᵢ/c. After the distances from the person to each one of the audio devices dᵢ are known, the position of the person in the audio environment may be found by using a triangulation method, a cost function minimization method, etc.

### Person Location Using Cross-IRs

We define a cross-IR as being an IR measured according to sound emitted by one audio device and captured by another audio device. A cross-IR may be represented as IRᵢⱼ(t), with i≠j. The approximate location of a person may be detected by monitoring the total energy in each one of the cross-IRs. Whenever a temporary reduction of the energy in one of the cross-IRs IRᵢⱼ(t) is detected, this could mean that someone or something, such as a person, is obstructing the line-of-sight between device i and device j. Therefore, the position of a sound-obstructing person, animal or thing may be determined to be in a line connecting device i and device j.

In some instances, a temporary reduction of the energy in a first cross-IR and a second cross-IR may be detected. In some such instances, the position of the person, animal or thing may be determined to be a the intersection of a line connecting device i and device j (the devices corresponding to the first cross-IR) with a line connecting device i′ and device j′ (the devices corresponding to the second cross-IR).

In some examples, a cross-IR-based location method may be alternative or complementary to a self-IR-based location method. Combining these techniques may provide added robustness and reliability. For example, with the cross-IR method the location of the person may sometimes be established to be in the line connecting device i and device j, so the space of search for the self-IR technique could be limited to the region around this line.

### Conference Room Example

A related configuration may include 1 loudspeaker and m microphones.

In some such examples, such a configuration may be implemented in a conference room. In some such examples m impulse responses IRᵢ(t) may be obtained, one TR corresponding to each microphone.

In one simple case, there may be a microphone in front of each sitting position in a conference room. By using an energy analysis method, it should be possible to determine, or at least to make a logical inference, whether there is a person seated in a particular sitting position or if the sitting position is vacant. According to some examples, different actions or responses may be triggered in each case. For example, if a control system determines that there is no seated person, the control system may cause the corresponding microphone feed to be muted. In other configurations there might not be a microphone corresponding to each seating position, and instead the microphones could be distributed over the room or concentrated in a microphone array. Even in such cases, by knowing the seating locations it should be possible to determine whether a given seat is occupied.

### Machine Learning Approaches

In some examples, acoustic responses measured by multiple devices may be combined with multiple analyses (such as energy, correlation in time and/or frequency representations, etc.) and multiple parameters for the analysis (e.g.: τ, T . . . ). This additional information has the potential to make the method potentially more powerful, but increases the difficulty and the computational overhead required for determining or estimating an underlying event in the audio environment. In such situations, a simple thresholding approach might not be practical or workable.

Instead, a machine learning approach may be applied in some such data-rich examples. In some such examples, a set of features may be generated. Each feature may, for example, correspond to a particular combination of a given transducer (or a particular audio device), a given analysis and a given set of parameters. In some such examples, a control system implementing a machine learning algorithm, such as a machine learning classifier, may learn to predict the environmental status from the set of input features.

According to some examples, a control system implementing a machine learning algorithm may be trained to identify the presence and/or location of a person based on the set of all acoustic responses. As in the single-device case, at least two approaches are possible. In one approach, a set of features may be generated. Each feature may, for example, correspond to a particular combination of a given transducer, a given analysis and a given set of parameters. The control system implementing the machine learning algorithm may learn to predict the presence of the person and/or their location, for example according to “ground truth” feedback from the person, from other sensors in the audio environment (such as one or more cameras), etc.

Another approach may involve end-to-end machine learning. For example, a control system implementing a machine learning algorithm may be provided with set of impulse responses (in time, frequency or a combination thereof) and may automatically learn to predict the changes of the environment based on the input impulse responses, without the need of any manually crafted features. One example of such a machine learning algorithm is a deep neural network.

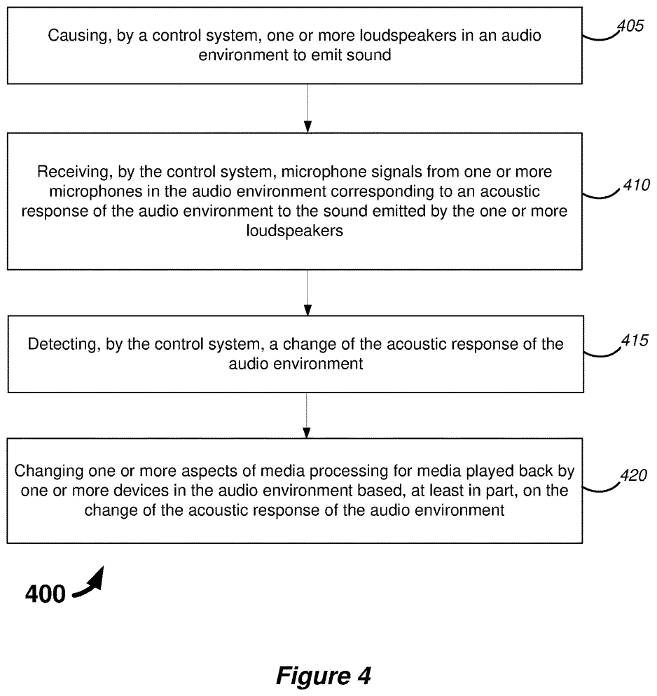

FIG. 4 is a flow diagram that outlines one example of a disclosed method. The blocks of method 400, like other methods described herein, are not necessarily performed in the order indicated. Moreover, such methods may include more or fewer blocks than shown and/or described. In this example, method 400 is an audio processing method.

The method 400 may be performed by an apparatus or system, such as the apparatus 300 that is shown in FIG. 3 and described above. In some such examples, the apparatus 300 includes at least the control system 310 shown in FIG. 3 and described above. In some examples, the blocks of method 400 may be performed by one or more devices within an audio environment, e.g., by an audio system controller (such as what may be referred to herein as a smart home hub) or by another component of an audio system, such as a smart speaker (such as one or more of the audio devices 110A-110D of FIG. 1A, one or more components thereof, etc.), a television, a television control module, a laptop computer, a mobile device (such as a cellular telephone), etc. In some implementations, the audio environment may include one or more rooms of a home environment. In other examples, the audio environment may be another type of environment, such as an office environment, an automobile environment, a train environment, a street or sidewalk environment, a park environment, etc. However, in alternative implementations at least some blocks of the method 400 may be performed by one or more devices that are configured to implement a cloud-based service, such as one or more servers.

In this example, block 405 involves causing, by a control system, one or more loudspeakers in an audio environment to emit sound. According to some examples, the sound emitted by the one or more loudspeakers may not be perceivable by humans. For example, the sound emitted by the one or more loudspeakers may not be in a frequency range that is audible to most human beings. In some examples, the sound emitted by the one or more loudspeakers may be hidden or masked, such as by implementing a maximum-length sequence (MLLS) method.

According to this example, block 410 involves receiving, by the control system, microphone signals from one or more microphones in the audio environment corresponding to an acoustic response of the audio environment to the sound emitted by the one or more loudspeakers. According to some examples, block 410 may involve receiving signals from a single microphone, or from a single microphone array. However, in other examples block 410 may involve receiving signals from microphones, or microphone arrays, in two or more audio devices.

In this example, block 415 involves detecting, by the control system, a change of the acoustic response of the audio environment. In some examples, detecting the change of the acoustic response of the audio environment may involve obtaining or estimating a current acoustic response of the audio environment and comparing the current acoustic response of the audio environment with a previous acoustic response of the audio environment. The previous acoustic response may, for example, have been obtained, or estimated, by the control system and may have previously been stored in a memory accessible by the control system. According to some examples, the acoustic response of the audio environment may be, or may correspond to, an impulse response.

In some examples, detecting the change of the acoustic response of the audio environment may involve an energy analysis, a correlation analysis or a combination thereof. According to some examples, detecting the change of the acoustic response of the audio environment may involve a time-based analysis, a frequency-based analysis, or a combination thereof. In some examples, detecting the change of the acoustic response of the audio environment may involve implementing a trained neural network. According to some examples, detecting the change of the acoustic response of the audio environment may involve implementing a machine learning classifier.

According to this example, block 420 involves changing one or more aspects of media processing for media played back by one or more devices in the audio environment based, at least in part, on the change of the acoustic response of the audio environment. In some examples, the media processing may involve audio processing, video processing, or a combination thereof. Alternatively, or additionally, method 400 may involve changing one or more aspects of lighting in the audio environment, changing a gain of one or more microphone signals, locking or unlocking one or more devices, or combinations thereof, based at least in part on the change of the acoustic response of the audio environment.

Some examples may involve estimating that the change of the acoustic response of the audio environment corresponds to a presence of one or more persons in the audio environment. Some such examples may involve estimating, by the control system, a location of the one or more persons. According to some examples, estimating the location of the one or more persons may be based, at least in part, on microphone signals received from a plurality of microphones in the audio environment, such as one or more microphones in each of a plurality of audio devices in the audio environment. In some such examples, estimating the location of the one or more persons may be based, at least in part, on sound emitted by a plurality of loudspeakers in the audio environment, such as one or more loudspeakers in each of a plurality of audio devices in the audio environment. According to some examples, the location of the one or more persons may be a home audio environment location (such as a chair or a sofa), a car seat location, a conference room location (such as a conference room seat location), etc.

In some examples, changing one or more aspects of the media processing may be based, at least in part, on the presence of the one or more persons in the audio environment. In some examples, changing one or more aspects of the media processing may involve changing a rendering process for sound played back by one or more audio devices in the audio environment based, at least in part, on the location of the one or more persons.

For example, referring to FIG. 2A, some examples may involve rendering audio played back from the audio devices 110A-110D based, at least in part, on the location of the person 205 in the audio environment 100. In some such examples, audio played back from the audio devices 110A-110D may be rendered to “push” audio away from the location of the person 205, such that there will be relatively lower loudspeaker activation in relatively closer proximity to the location of the person 205. Such examples may be beneficial if the person 205 is uttering, or is likely to utter, a wakeword or a voice command, is involved in a telephone call, etc.

In another example, changing a rendering process for sound played back by one or more audio devices in the audio environment may involve “pulling” audio towards the location one or more persons in the audio environment.

Referring again to FIG. 2A, audio played back from the audio devices 110A-1 OD may be rendered to “pull” audio towards the location of the person 205, such that there will be relatively higher loudspeaker activation in relatively closer proximity to the location of the person 205.

Alternatively, or additionally, changing a rendering process for sound played back by one or more audio devices in the audio environment may involve optimizing the spatial reproduction of audio in an audio environment based, at least in part, on the location of the one or more persons in the audio environment. For example, referring again to FIG. 2A, audio may be rendered in an attempt to optimize the spatial reproduction of audio played back from the audio devices 110A-110D based, at least in part, on the estimated location of the person 205, an estimated orientation of the person 205, or a combination thereof.

Some examples of pushing, pulling and rendering optimization are disclosed in United States Patent Publication No. 2022/0272454, entitled “Managing Playback of Multiple Streams of Audio over Multiple Speakers,” which is hereby incorporated by reference, particularly on pages 15 through 20 and FIGS. 2F through 5C.

Some examples may involve, estimating, by the control system, that the change of the acoustic response of the audio environment corresponds to an arrival of one or more persons to the audio environment or a departure of one or more persons from the audio environment. In some instances, the control system may determine, or estimate, that the change of the acoustic response of the audio environment corresponds to the arrival of the one or more persons to the audio environment. In some such examples, method 400 may involve initiating or resuming media playback by one or more devices in the audio environment. In some instances, the control system may determine, or estimate, that the change of the acoustic response of the audio environment corresponds to the departure of the one or more persons from the audio environment. In some such examples, method 400 may involve stopping or pausing media playback by one or more devices in the audio environment.

Alternatively, or additionally, method 400 may involve dimming the lighting in the audio environment if the change of the acoustic response is interpreted to correspond to the departure of a person from the audio environment, brightening the lighting in the audio environment if the change of the acoustic response is interpreted to correspond to the entry of a person into the audio environment, or a combination thereof. In another example, method 400 may involve increasing the gain of microphone signals in one or more audio devices that are estimated to be close to a person in the audio environment. In some examples, method 400 may involve locking one or more devices if the change of the acoustic response is interpreted to correspond to the departure of a person from the audio environment, unlocking one or more devices if the change of the acoustic response is interpreted to correspond to the entry of a person into the audio environment, or a combination thereof.

Some aspects of present disclosure include a system or device configured (e.g., programmed) to perform one or more examples of the disclosed methods, and a tangible computer readable medium (e.g., a disc) which stores code for implementing one or more examples of the disclosed methods or steps thereof. For example, some disclosed systems can be or include a programmable general purpose processor, digital signal processor, or microprocessor, programmed with software or firmware and/or otherwise configured to perform any of a variety of operations on data, including an embodiment of disclosed methods or steps thereof. Such a general purpose processor may be or include a computer system including an input device, a memory, and a processing subsystem that is programmed (and/or otherwise configured) to perform one or more examples of the disclosed methods (or steps thereof) in response to data asserted thereto.

Some embodiments may be implemented as a configurable (e.g., programmable) digital signal processor (DSP) that is configured (e.g., programmed and otherwise configured) to perform required processing on audio signal(s), including performance of one or more examples of the disclosed methods. Alternatively, embodiments of the disclosed systems (or elements thereof) may be implemented as a general purpose processor (e.g., a personal computer (PC) or other computer system or microprocessor, which may include an input device and a memory) which is programmed with software or firmware and/or otherwise configured to perform any of a variety of operations including one or more examples of the disclosed methods. Alternatively, elements of some embodiments of the inventive system are implemented as a general purpose processor or DSP configured (e.g., programmed) to perform one or more examples of the disclosed methods, and the system also includes other elements (e.g., one or more loudspeakers and/or one or more microphones). A general purpose processor configured to perform one or more examples of the disclosed methods may be coupled to an input device (e.g., a mouse and/or a keyboard), a memory, and a display device.

Another aspect of present disclosure is a computer readable medium (for example, a disc or other tangible storage medium) which stores code for performing (e.g., coder executable to perform) one or more examples of the disclosed methods or steps thereof.

Various aspects of the present invention may be appreciated from the following Enumerated Example Embodiments (EEEs):

EEE 1. An audio processing method, comprising:
causing, by a control system, one or more loudspeakers in an audio environment to emit sound;
receiving, by the control system, microphone signals from one or more microphones in the audio environment corresponding to an acoustic response of the audio environment to the sound emitted by the one or more loudspeakers;
detecting, by the control system, a change of the acoustic response of the audio environment; and
changing one or more aspects of media processing for media played back by one or more devices in the audio environment based, at least in part, on the change of the acoustic response of the audio environment.
   EEE 2. The method of EEE 1, further comprising estimating, by the control system, that the change of the acoustic response of the audio environment corresponds to a presence of one or more persons in the audio environment.
   EEE 3. The method of EEE 2, further comprising estimating, by the control system, a location of the one or more persons.
   EEE 4. The method of EEE 3, wherein changing the one or more aspects of the media processing involves changing a rendering process for sound played back by one or more audio devices in the audio environment based, at least in part, on the location of the one or more persons.
   EEE 5. The method of EEE 3 or EEE 4, wherein estimating the location of the one or more persons is based, at least in part, on microphone signals received from a plurality of microphones in the audio environment.
   EEE 6. The method of EEE 5, wherein estimating the location of the one or more persons is based, at least in part, on sound emitted by a plurality of loudspeakers in the audio environment.
   EEE 7. The method of any one of EEEs 2-6, wherein changing the one or more aspects of the media processing is based, at least in part, on the presence of the one or more persons in the audio environment.
   EEE 8. The method of any one of EEEs 1-7, further comprising estimating, by the control system, that the change of the acoustic response of the audio environment corresponds to an arrival of one or more persons to the audio environment or a departure of one or more persons from the audio environment.
   EEE 9. The method of EEE 8, wherein the change of the acoustic response of the audio environment corresponds to the arrival of the one or more persons to the audio environment, further comprising initiating or resuming media playback by one or more devices in the audio environment.
   EEE 10. The method of EEE 8, wherein the change of the acoustic response of the audio environment corresponds to the departure of the one or more persons from the audio environment, further comprising stopping or pausing media playback by one or more devices in the audio environment.
   EEE 11. The method of any one of EEEs 1-10, wherein detecting the change of the acoustic response of the audio environment involves energy analysis, correlation analysis or a combination thereof.
   EEE 12. The method of any one of EEEs 1-11, wherein detecting the change of the acoustic response of the audio environment involves a time-based and frequency-based analysis.
   EEE 13. The method of any one of EEEs 1-10, wherein detecting the change of the acoustic response of the audio environment involves implementing a trained neural network.
   EEE 14. The method of any one of EEEs 1-10, wherein detecting the change of the acoustic response of the audio environment involves implementing a machine learning classifier.
   EEE 15. The method of any one of EEEs 1-14, wherein the acoustic response of the audio environment is, or corresponds to, an impulse response.
   EEE 16. The method of any one of EEEs 1-15, wherein the sound emitted by the one or more loudspeakers is not perceivable by humans.
   EEE 17. The method of any one of EEEs 1-16, wherein the media processing involves audio processing, video processing, or a combination thereof.
   EEE 18. The method of any one of EEEs 1-17, wherein detecting the change of the acoustic response of the audio environment involves estimating a current acoustic response of the audio environment and comparing the current acoustic response of the audio environment with a previous acoustic response of the audio environment.
   EEE 19. The method of EEE 18, further comprising estimating, by the control system and prior to estimating the current acoustic response of the audio environment, the previous acoustic response of the audio environment.
   EEE 20. The method of any one of EEEs 1-19, further comprising changing one or more aspects of lighting in the audio environment based, at least in part, on the change of the acoustic response of the audio environment.
   EEE 21. The method of any one of EEEs 1-19, further comprising changing a gain of one or more microphone signals based, at least in part, on the change of the acoustic response of the audio environment.
   EEE 22. The method of any one of EEEs 1-19, further comprising locking or unlocking one or more devices based, at least in part, on the change of the acoustic response of the audio environment.
   EEE 23. An apparatus configured to implement the method of any one of EEEs 1-22.
   EEE 24. A system configured to implement the method of any one of EEEs 1-22.
   EEE 25. One of more non-transitory media having software stored thereon, the software including instructions for controlling one or more devices to implement the method of any one of EEEs 1-22.

While specific embodiments of the present disclosure and applications of the disclosure have been described herein, it will be apparent to those of ordinary skill in the art that many variations on the embodiments and applications described herein are possible without departing from the scope of the disclosure described and claimed herein. It should be understood that while certain forms of the disclosure have been shown and described, the disclosure is not to be limited to the specific embodiments described and shown or the specific methods described.

1. An audio processing method, comprising:
causing, by a control system, loudspeakers of each of a plurality of devices in an audio environment to emit sound;
receiving, by the control system, microphone signals from microphones of each of the plurality of devices corresponding to an acoustic response of the audio environment to the sound emitted by the loudspeakers;
detecting, by the control system, a change of the acoustic response of the audio environment based on the microphone signals received from the microphones of each of the plurality of devices corresponding to the acoustic response of the audio environment to the sound emitted by the loudspeakers; and
changing one or more aspects of media processing for media played back by one or more of the plurality of devices in the audio environment based, at least in part, on the change of the acoustic response of the audio environment.

2. The method of claim 1, further comprising estimating, by the control system, that the change of the acoustic response of the audio environment corresponds to a presence of one or more persons in the audio environment.

3. The method of claim 2, further comprising estimating, by the control system, a location of the one or more persons.

4. The method of claim 3, wherein changing the one or more aspects of the media processing involves changing a rendering process for sound played back by one or more of the plurality of devices in the audio environment based, at least in part, on the location of the one or more persons.

5. The method of claim 2, wherein changing the one or more aspects of the media processing is based, at least in part, on the presence of the one or more persons in the audio environment.

6. The method of claim 1, further comprising estimating, by the control system, that the change of the acoustic response of the audio environment corresponds to an arrival of one or more persons to the audio environment or a departure of one or more persons from the audio environment.

7. The method of claim 6, wherein the change of the acoustic response of the audio environment corresponds to the arrival of the one or more persons to the audio environment, further comprising initiating or resuming media playback by one or more of the plurality of devices in the audio environment.

8. The method of claim 6, wherein the change of the acoustic response of the audio environment corresponds to the departure of the one or more persons from the audio environment, further comprising stopping or pausing media playback by one or more of the plurality of devices in the audio environment.

9. The method of claim 1, wherein detecting the change of the acoustic response of the audio environment involves energy analysis, correlation analysis or a combination thereof.

10. The method of claim 1, wherein detecting the change of the acoustic response of the audio environment involves a time-based and frequency-based analysis.

11. The method of claim 1, wherein detecting the change of the acoustic response of the audio environment involves implementing a trained neural network.

12. The method of claim 1, wherein detecting the change of the acoustic response of the audio environment involves implementing a machine learning classifier.

13. The method of claim 1, wherein the acoustic response of the audio environment is, or corresponds to, an impulse response.

14. The method of claim 1, wherein the sound emitted by the loudspeakers is not perceivable by humans.

15. The method of claim 1, wherein the media processing involves audio processing, video processing, or a combination thereof.

16. The method of claim 1, wherein detecting the change of the acoustic response of the audio environment involves estimating a current acoustic response of the audio environment and comparing the current acoustic response of the audio environment with a previous acoustic response of the audio environment.

17. The method of claim 16, further comprising estimating, by the control system and prior to estimating the current acoustic response of the audio environment, the previous acoustic response of the audio environment.

18. The method of claim 1, further comprising changing one or more aspects of lighting in the audio environment based, at least in part, on the change of the acoustic response of the audio environment.

19. The method of claim 1, further comprising changing a gain of one or more microphone signals of the plurality of the devices based, at least in part, on the change of the acoustic response of the audio environment.

20. The method of claim 1, further comprising locking or unlocking one or more of the plurality of devices based, at least in part, on the change of the acoustic response of the audio environment.

21. An apparatus comprising a processor configured to implement the method of claim 1.

22. (canceled)

23. (canceled)
